(19) United States
(12) Patent Application Publication
(10) Pub. No.: US 2005/0273626 A1
(43) Pub. Date: Dec. 8, 2005

(54) System and method for portable authentication

(76) Inventors: Steven Pearson, Santa Barbara, CA (US); Matteo Contolini, Santa Barbara, CA (US)

Correspondence Address: HARNESS, DICKEY & PIERCE, P.L.C., P.O. BOX 828, BLOOMFIELD HILLS, MI, 48303, US

(21) Appl. No.: 10/859,487

(22) Filed: Jun. 2, 2004

(51) Int. Cl. H04K 1/00

(52) U.S. Cl. 713/186

(57) ABSTRACT

A portable device, such as a cellular telephone, engages the user in a challenge-response sequence that is based on recognition of the user's utterance and also upon verification of the user's speech patterns or voiceprint. The challenge-response protocol presents the user with an unexpected challenge word, which the user is then requested to respond to. The system maintains a secure data store of challenge words which it adapts and augments as the user makes use of the portable device. The portable device provides the user with a convenient, single access point through which he or she can authenticate with a variety of disparate secure devices ranging from door locks, ATM machines, financial institutions and third-party business associates.

### BACKGROUND OF THE INVENTION

The present invention relates generally to authentication and access control. More particularly, the invention relates to a portable authentication device using speech biometrics and adapted for use with numerous, disparate types of locks and other controlled systems.

The need for personal authentication permeates virtually every aspect of modern day life. To a greater or lesser degree, keyed and keyless entry systems, personal identification numbers (PIN numbers), user ID and password combinations, and the like, all provide some measure of personal authentication with which to ensure privacy and protect personal property and information. Traditional approaches to personal authentication tend to focus on one application at a time and typically require a different authentication technique for each application. For example, a physical key is used for house and suitcase; a combination lock is used for safe or bicycle; short-range wireless key fobs are used for cars; magnetic cards or smart cards, with associated PIN number are used for ATM machines and fixed passwords are used for e-mail access and stock account access. Learning all of these techniques, and keeping track of the various keys, secret codes and devices can present a problem.

Of even greater concern, all of the traditional personal authentication methods suffer from vulnerability to break-in and basic inconvenience. For example, door locks are both vulnerable to physical break-in attack and inconvenience. Everyone has no doubt experienced the inconvenience of having to fumble through a bunch of keys in the dark to find the right one. Similarly, typing in a password or PIN number is inconvenient, cumbersome and insecure. Passwords or PIN numbers can be discovered by covert observation, as the number is being entered or afterwards as it is sent to the secured system for processing and access control.

Various new approaches have been proposed to deal with the foregoing problems. For example, biometric information obtained from the user has been suggested as a convenient and fairly secure authentication technology. Wireless transmission from a handheld device has the advantage of portability and can alleviate fumbling with keys or typing a PIN number. Smartcards pack a high level of computational power and memory into a portable device of minimal size. Thus some have suggested using smartcards for authentication. Finally, modern encryption techniques can be used to protect information traveling from one point to another. Yet, with all of these advances in authentication technology, no one system and method works across many applications, while at the same time giving a high level of security, convenience and low cost.

### SUMMARY OF THE INVENTION

The present invention provides a unified portable authentication system that integrates well with modern day security technologies and which works across many applications. As will be more fully explained herein, the portable authentication device can readily provide authentication services for a disparate range of devices including, without limitation, house, car, ATM machine, e-mail and financial accounts, and even the mundane bicycle lock. The authentication device uses speech for the verification key in an advantageous way. The system uses speech as a complex key that does not have to be remembered by the user. Also, as opposed to other forms of biometric data, speech is utilized in the present system in a challenge-response approach. This means that the key can be changed for each use, thus inhibiting copying. The challenge-response approach may be used in a text-dependent speaker verification system, a text-independent speaker verification system, or a new kind of text-dependent speaker verification that forms a part of this invention.

As will be more fully appreciated from a review of the remaining specification, the portable authentication system and method of the invention solves a major problem with current biometric approaches, namely that high quality biometric data are needed for reliable authentication, yet if these data are stolen, the user's security through biometrics is permanently compromised. Prior art biometric authentication techniques are inherently limited in this regard. The system and method for portable authentication can be conveniently embedded in any portable device. For illustration purposes here, a cellular telephone has been featured as an example of such a portable device. Of course, other portable devices can be used instead.

The system for performing authentication to a secure system (which can be any system, such as home lock, car lock, ATM machine, financial account, bicycle padlock, telephone system, and the like) provides a portable device having a communication module capable of communicating with at least one secure system. A speech processing module is adapted to process a user authentication utterance. An authentication logic module communicates with the speech processing module and operates to analyze the authentication utterance processed by the speech processing module. The authentication logic module cooperates with the communication module to send authorization indicia to the secure system based on the results analyzing said authentication utterance. The authorization indicia can be an “unlock” command, or a message used to the secure system to permit or negotiate access to the system.

The method of performing authentication to a secure system thus employs the steps of receiving a speech utterance from a user into a portable device; processing said speech utterance in said portable device to authentication indicia;

using said authentication indicia to generate an authentication command, and communicating said authentication command to said secure system.

For a more complete understanding of the invention, its objects and advantages, refer to the remaining specification and to the accompanying drawings. Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a system lock diagram illustrating a presently preferred implementation of the portable authentication system and method;

FIG. 2 is a data flow diagram illustrating another embodiment of the portable authentication system and method;

FIG. 3 is a use case diagram useful in understanding the principles of the invention.

### DETAILED DESCRIPTION OF THE PREFERRED EMBODIMENTS

The following description of the preferred embodiment(s) is merely exemplary in nature and is in no way intended to limit the invention, its application, or uses.

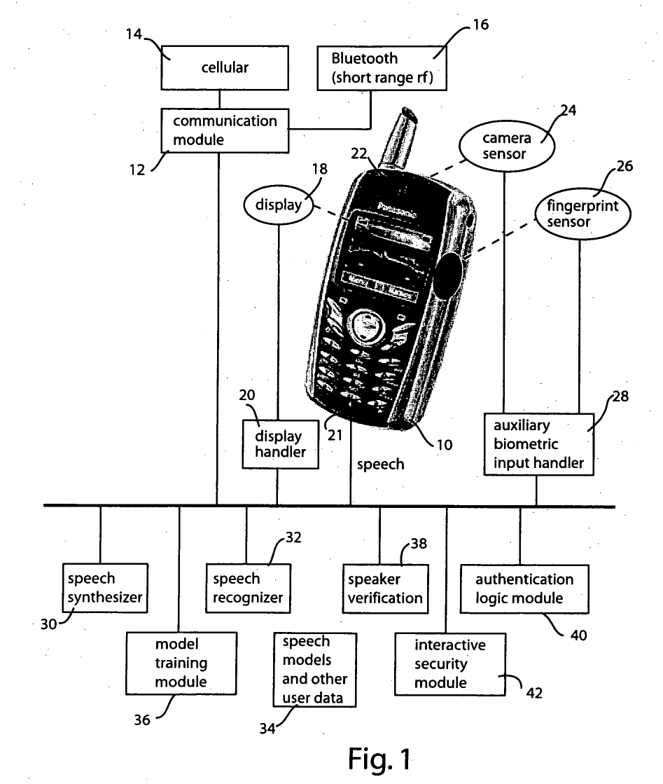

Referring to FIG. 1, an exemplary implementation of the portable authentication system and method has been illustrated. For purposes of illustration, the portable device has been shown as a cellular telephone 10. The cellular telephone represents a convenient implementation of the invention. However, it will be appreciated that the invention is capable of being deployed in a variety of different types of portable devices. Such portable devices include personal digital assistance (PDAs), key fobs, smart cards, personal audio systems and wearable devices. Other portable devices in addition to these are also envisioned.

The cellular telephone embodiment illustrated in FIG. 1 inherently includes a communication module 12 by which the device communicates wirelessly via a cellular telephone link 14 and also optionally by another communication link, such as short range radio frequency (RF) signal. For purposes of illustration, cellular phone 10 includes the capability to communicate Bluetooth as illustrated at 16. The cellular telephone also includes a convenient display 18 that is normally used to display telephone numbers, photographs and text messages, such as e-mail or instant messages. As will be more fully explained herein, the display 18 is responsive to a display handler software module 20 that adapts the display for use in facilitating and providing authentication services. The cellular telephone 10 also includes a microphone audio input port 21 and a speaker or earpiece 22 for audio output.

Although not required, the cellular telephone 10 may also include a camera sensor 24 that can be used to obtain additional biometric information, such as a visual scan of the user's face, or iris. In addition, if desired, a fingerprint sensor 26 can be incorporated into the cellular phone, such as into the side housing of the phone where it is easily located for fingerprint reading. The camera sensor and fingerprint sensor supply biometric data to the auxiliary biometric input handler module 28. Use of such auxiliary biometric data can enhance the security capabilities of the portable device for authentication use. However, such biometric data are optional in one presently preferred embodiment, which utilizes the user's speech to perform the authentication function. Thus the camera sensor and fingerprint sensor serve as additional components of biometric data where desired.

The portable authentication device further includes several speech components that allow the device to perform the authentication function using speech for the verification key. In the illustrated embodiment, a speech synthesizer 30 and speech recognizer 32 are provided. The speech recognizer is preferably a model-based recognizer that employs a stored set of speech models 34 that are used by the recognizer in performing speech recognition. The presently preferred embodiment of FIG. 1 includes a model training module 36 that is used to train or adapt the speech models 34 so that the system is capable of continuously improving its ability to recognize the user's voice and speech patterns.

In addition to the recognizer 32, the illustrated embodiment also includes a speaker verification module 38. Whereas the speech recognizer's primary function is to recognize the utterances of the user and convert them into an information-bearing form such as text, the speaker verification module is designed to analyze the voice qualities of the user to determine whether the speaker is an authorized speaker or an imposter. In a practical implementation, many of the speech recognizer and speaker verification functions can be performed by the same software modules. Thus these have been shown as separate modules in FIG. 1 primarily for functional illustration purposes.

The portable device also includes sophisticated logic modules for performing the authentication function based on the user's speech, and also optionally based on other biometric data. For illustration purposes, two authentication and security modules are illustrated in FIG. 1. The authentication logic module 40 performs the lower level authentication functions comparing the user's speech with stored data. The interactive security module 42 provides higher level security functions as will be more fully explained. These higher level functions allow the portable device to participate in challenge-response dialogues with the user as well as providing the interface functions to allow the portable device to work across many different application platforms.

Instead of using a fixed challenge-response message, the interactive security module 42 may be configured to prompt the user with an unexpected challenge. The system might, for example, ask the user to utter a certain word or phrase. The system would generate the challenge message, on the fly, by selecting a word or phrase from previously stored tokens that were extracted during the user's normal use of the portable device (e.g., as a cell phone). The system would present the challenge in the form of a message “Please say this . . . ” where the duly-selected token from the user's past speech would be acoustically altered in some way so that the bearer of the portable device could not simply mimic it. Alternatively, the challenge message can be displayed to the user on the device display, prompting the user to say what is displayed. Once the challenge-response was correctly authenticated, the system could instruct the ATM machine to perform the requested transaction. If desired, the system may be preprogrammed so the transaction provided would be the user's favorite transaction.

Were a thief to steal the user's cell phone and use it in an effort to break into the user's account, the speaker verification system would make it very difficult to mimic the user. First, because the challenge-response sequence is, in effect, a rolling sequence, the thief would have no way to know in advance what utterance would be required. Thus if the thief tape recorded the user interacting with the device in a previous session, that information would be irrelevant during the subsequent use. The system may be further configured so that after several failed attempts, some addition action will be initiated by the system. The secure memory can be erased and a phone call may be placed, giving GPS information and other information that can be sent to a police computer or to a third party with a prerecorded message indicating suspicion of trouble.

While FIG. 1 has illustrated the principal components that would be embedded in the portable device, the authentication system and method is adapted for deployment across multiple devices, where portions of the authentication process may take place in secure systems, such as on a secure server located remote from the portable device. The interactive security module 42 and authentication logic module 40 mediate this process, with communication between the portable device and the secure server being effected through the communication module 12, using whatever form of communication protocol is available.

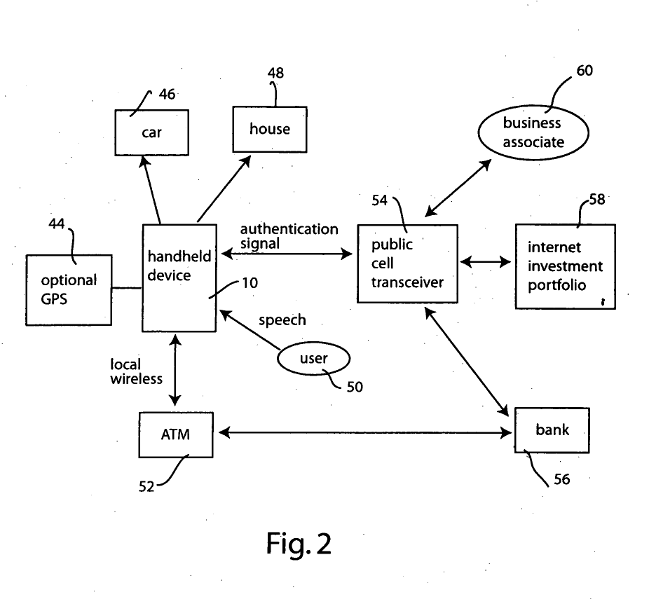

FIG. 2 illustrates the distributed nature of the system and method for portable authentication. Referring to FIG. 2, the portable device has been depicted at 10 as a handheld device. If desired, the handheld device may include an optional GPS module 44 to provide location information useful in mediating the authentication process. In the illustrated embodiment of FIG. 2, handheld device 10 communicates, preferably wirelessly, with the user's car 46 and house 48. Once the user has been properly authenticated, handheld device 10 is configured to send a suitable lock/unlock signal to the car 46 or house 48. As illustrated, the user 50 communicates with the handheld device 10 using speech. The details of the speech interaction between the user and the handheld device will be detailed below.

The handheld device 10 is also capable of communicating with secure systems operated by third parties. For purposes of illustration, an ATM machine has been shown at 52. The handheld device 10 may communicate with the ATM machine using a local wireless communication channel, such as a Bluetooth communication channel. As an alternative, if the ATM machine is not capable of communicating using Bluetooth, an alternate means is provided through the public cellular transceiver system 54. In this case, the handheld device 10 communicates using cellular telephone technology to transceiver 54. The transceiver is, in turn, in communication with the bank 56 or other controlling institution that is responsible for mediating use of the ATM machine 52. Thus, using speech, the user 50 can communicate with the handheld device 10, causing the handheld device to effect an authentication process. This process can be performed entirely within the handheld device, or portions or all of the authentication process can be handled by a third party system, such as a system located at bank 56. Once the authentication process is complete, the user can utilize the handheld device 10 to communicate his or her banking instructions to the ATM machine 52. Thus, once the user has been authenticated, he or she can make a withdrawal or deposit by speaking his or her intentions to the ATM machine through the handheld device 10.

In some instances the user may not be directly accessing a physical structure such as an ATM machine, but rather a virtual structure, such as an online investment portfolio 58. For example, the user may be accessing an internet investment portfolio account using a personal computer. Rather than rely on potentially insecure authentication methods by typing user ID and password information into the computer, the user can again invoke the handheld device to perform the authentication required. The user would thus log onto the investment portfolio site, indicate through suitable means that the user wishes to use a portable device for authentication, and then interact with the handheld device to effect the authentication. In this regard, the user's handheld device may initiate a call to the software system that is mediating the investment portfolio site, or the investment portfolio site can initiate the call by placing a call to the user's handheld device. In either case, once a connection is established, authentication proceeds in essentially the same fashion as it does for unlocking the car or house, or negotiating a transaction with the ATM machine.

While many of the uses of the personal authentication system are likely to involve interaction with a secure device or secure account, the portable authentication system has other uses as well. There are numerous times in business transactions where one party will need to authenticate himself or herself to another party. For example, the user 50 may be transacting business with a business associate 60. If the user and business associate are well acquainted, they will traditionally rely on personal recognition of each other's voice to ensure that the proper parties are communicating. However, there are numerous occasions where one or both parties may not be sufficiently familiar to recognize the voice of the other. The personal authentication system can be used to handle this situation as well. In essence, the user 50 would interact with a comparable device in possession of the business associate 60. The business associate would do likewise. Thus after a brief authentication session by each, both parties can be notified by their handheld devices that the party on the other end of the line is authenticated.

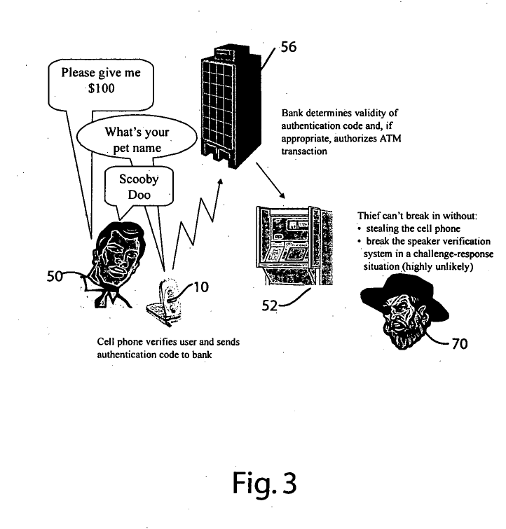

By way of further illustration, refer now to the use case diagram of FIG. 3. As illustrated, the portable authentication system can be effectively used to allow the authenticated user to interact with a secure device, while preventing a thief from doing so. The illustrated embodiment implements a form of challenge-response interaction where a portion of the authentication process is handled by the portable device and another portion is handled by the secure third party server, in this case the bank's authentication server that mediates operation of the ATM machine. The process begins by the user speaking into the portable device a request such as a request to make a withdrawal, “Please give me one hundred dollars.” The portable authentication system analyzes the user's speech in two respects. First, the speech recognizer 32 (FIG. 1) ascertains the meaning of the user's input utterance, namely that the user wishes to make a withdrawal of a certain amount. Concurrently, the speaker verification module 38 is analyzing the speaker's voice to determine whether the speaker is authentic. To further authenticate the speaker, a challenge message is generated and played through the speaker or earpiece using the speech synthesizer 30. The challenge message can be a fixed challenge message, or it can be a rolling message that changes each time. For example, as illustrated, the challenge could ask the user to supply a previously stored piece of information such as, “What is your pet's name.” The user responds with the correct information, which the speech recognizer 32 is able to decipher and pass to the authentication logic module 40 and interactive security module 42.

Once this initial authentication sequence has been properly effected, and authentication code is sent from the portable device to the bank 56. The authentication code can be a predefined access code, comparable to a user ID and a PIN number. Alternatively, the authentication code, itself, can be involved in a rolling code challenge-response sequence. In the latter case, the computer system at the bank would issue a further challenge to the user, which the user would respond to by appropriate verbal response. After the authentication code has been verified by the bank, the bank then authorizes the ATM transaction. It will be seen that the portable authentication system and method provides a high degree of security. A thief 70 cannot access the user's ATM account without (a) stealing the user's cell phone and (b) breaking the speaker verification system in a challenge-response situation.

### Details of Implementation

It is preferred that the portable device should have a secure mechanism for protecting the private data stored within it. This may be accomplished by storing a portion or all of the verification algorithms and the private data needed to effect those algorithms in an isolated computer that is not openly accessible to the outside. In one embodiment, the isolated computer can be located at a remote site that has been suitably secured, such as a server at the bank. In an alternate embodiment, a single integrated circuit that includes CPU, RAM, ROM, audio input and a serial interface may be provided on the portable device. The integrated circuit would be adapted to allow private data to be shown only upon successful verification. A higher level controller would then be employed within the handheld device that would communicate with this single integrated circuit through the serial interface during an authentication session. A question and answer series would be set up at or near the point of purchase which may serve as a backup in case the biometric authentication mechanism fails.

To protect the authentication signal as it is sent from the device to a service provider, such as to the bank, an e-certificate may be used. Each service provider (e.g., bank) loads a list of large random numbers into the user's portable device and also keeps a copy for themselves. Preferably this loading would be done in person, at the service provider location, and subsequently these numbers would be protected as private data within the secure integrated circuit. Each time authentication is necessary, the portable device will send the next random number from the list. None of the random numbers would be usable twice. This technique can be further enhanced, for example, by combining a time stamp with the random number or by using the random numbers in sequence as an encryption/decryption key for the message.

There are a number of different techniques that may be used to implement the challenge-response models within the preferred embodiments. Models may be constructed by collecting one or more examples of the user's speech and by then computing statistical data such as the means and variances of relevant speech parameters. In this way a template is defined that will be used in later speaker verification matching. If the data is collected automatically two things should be ensured: (1) that a given token is of the same word or words and (2) that the speech source is the correct person. After that, normalization may be required if averaging is performed. There are several methods to accomplish this:

In one method, the actual word or words are never known by the system. Instead, certain tokens are selected from monitored conversations and then saved in memory. Such monitored conversations can be extracted, for example, when the user is using his or her cellular telephone. In subsequent conversations, if one of the saved tokens is adequately matched, using dynamic time warping (DTW) word spotting, then this token can be pooled with the previous tokens. In this way the model grows. A saved token that is not getting matches is discarded. For presenting a challenge word during verification, one of the tokens from one of the “pools” can be distorted and played to the user, along with “please say this.” That it is the correct person making the models can be ensured, since an impostor would need to have the device for quite a while before tokens from his or her speech would be used for a template. By this time, the theft would be discovered.

A second method, the system starts out with a speaker-independent recognition system and then “bootstraps” from there. If words from the internal dictionary are spotted in phone conversations, using the speech recognition module, then these can be used to build models. At a later time, challenge words are selected at random from models that grew to an adequate level during this training process.

Further on the point of collecting models for subsequent use in challenge-response security, it can be expected that in the future many people will carry a single portable electronic device with multiple capabilities, including communication, computation, information presentation, and the like. The cellular telephone is already becoming that device. Through the model collecting and building process described above, the user becomes “bonded” to his or her portable device (e.g., cell phone) such that the device learns to know when it is in possession of the owner. An extreme case of such knowledge might be that the device is physically attached to the owner, as detected by suitable biometric information. When the device is adequately confident that it is in possession of the owner, it can serve as a proxy of the owner for certain tasks, such as authentication, as discussed above. Thus the portable device, whether it be a cell phone or some other device, should preferably be configured so that it will “bond” with its owner over time. As explained previously, such bonding is unobtrusively and reliably performed by using the automatic speaker verification system, with an automatic building of speech models. A high degree of security may then be afforded by relying on the “local” high quality audio channel (between the user and his or her portable device) coupled with a challenge-response method that achieves a practical performance level. Additional multimodal methods, including using additional biometrics, can be integrated for even better “bonding” performance.

From the foregoing it will be appreciated that the portable authentication system and method preferably includes speech processing and wireless capability, together with a character display. The character display may be used, for example, to provide a visual display of a combination lock number or other pin number that the user would then utilize manually. Such visual display makes the system backward compatible with locking technologies that are not inherently capable of wireless communication (such as a conventional padlock or bicycle lock). The portable device would, in this instance, help the user remember his or her lock number.

Frequent use of the device allows unobtrusive training for high quality speech models and a challenge-response system. This is one of the important advantages of the invention. In addition, a preferred embodiment may include provision for protecting biometric models, PIN numbers and private data through the use of dedicated integrated circuits or silicon area. The preferred embodiments may also implement high security means for wireless output of the authentication signal (using encryption and/or e-certificates). Using the speech synthesis module, a secret access code can be spoken to the user instead of displaying it on the LCD screen. This makes the invention well-suited for use by handicapped persons.

The time window for sending (or displaying an output authentication signal, following a verification procedure, may be adjustable depending on the confidence that the device remains with the user. For example, there would be a high confidence while the device is attached to the user's body, as with a wristwatch cell phone, or the like.

While the basic authentication system illustrated above is primarily used to provide personal access, the invention can be readily extended to provide automatic notification to a third party when a break-in is attempted. Moreover, although the illustrated embodiments have focused primarily on a single user accessing multiple different secure applications, it is possible to utilize a single device with multiple users. This is done by including user profiles and additional private memory for each user. This would allow several family members, for example, to use the same portable device to gain access to the house. It would be possible to configure the access codes so that all members of the family cannot access the financial institution records for ATM machines, thereby allowing parents to control what their children may have access to.

The description of the invention is merely exemplary in nature and, thus, variations that do not depart from the gist of the invention are intended to be within the scope of the invention. Such variations are not to be regarded as a departure from the spirit and scope of the invention. Thus, while the invention has been described in its presently preferred embodiments, it will be understood that the invention is capable of modification without departing from the spirit of the invention as set forth in the appended claims.

1. A system for performing authentication to a secure system comprising:
a portable device having a communication module capable of communicating with at least one secure system;
a speech processing module adapted to process a user authentication utterance;
an authentication logic module that communicates with said speech processing module and operates to analyze said authentication utterance processed by said speech processing module;
said authentication logic module cooperating with said communication module to send authorization indicia to said secure system based on the results analyzing said authentication utterance.

2. The system of claim 1 wherein said authentication logic module is configured to provide authorization indicia to plural secure systems.

3. The system of claim 1 wherein said speech processing module includes a speaker verification module that analyzes qualitative aspects of the user's utterance and compares said qualitative aspects with previously obtained information about said user's speech.

4. The system of claim 1 wherein said portable device is a cellular telephone.

5. The system of claim 3 wherein said portable device is a voice operated device and wherein said previously obtained information about said user's speech is obtained while the user is operating said voice operated device.

6. The system of claim 5 wherein said voice operated device is a cellular telephone.

7. The system of claim 1 wherein said authentication logic module mediates a challenge-response dialogue with said user.

8. The system of claim 7 wherein said challenge-response dialogue includes a challenge message presented to the user that prompts the user to utter information based on the challenge message.

9. The system of claim 8 wherein said challenge message is presented audibly.

10. The system of claim 8 wherein said speech processing module includes a speech synthesizer and wherein said challenge message is presented audibly using said speech synthesizer.

11. The system of claim 8 wherein said challenge message is presented visually.

12. The system of claim 8 wherein said challenge message is determined by the authentication logic module based on information previously obtained from the user.

13. The system of claim 12 wherein said previously obtained information is obtained from the user's speech.

14. The system of claim 1 further comprising at least one auxiliary biometric data input that supplies biometric information used by the authentication logic module.

15. The system of claim 14 wherein said biometric data input is a camera sensor.

16. The system of claim 14 wherein said biometric data input is a fingerprint sensor.

17. The system of claim 1 further comprising a display handler for presenting information upon an associated display, wherein said display handler is responsive to said authentication logic module to supply a user with authentication information associated with the secure system upon authentication.

18. A method of performing authentication to a secure system comprising:
receiving a speech utterance from a user into a portable device;
processing said speech utterance in said portable device to authentication indicia;
using said authentication indicia to generate authentication indicia, and
communicating said authentication indicia to said secure system.

19. The method of claim 18 wherein said processing step includes performing speaker verification upon said speech utterance.

20. The method of claim 18 wherein said processing step includes a challenge-response dialogue with said user.

21. The method of claim 20 wherein said challenge-response dialogue includes prompting the user to supply a predetermined utterance.

22. The method of claim 20 wherein said challenge-response dialogue includes prompting the user to supply a predetermined utterance based on previously obtained speech from said user.

23. The method of claim 18 further comprising displaying an authentication indicia using said portable device.

24. The method of claim 18 further comprising using said portable device to communicate said authentication indicia to said secure system.

25. The method of claim 18 further comprising obtaining auxiliary biometric data from said user and using said auxiliary biometric data in generating said authentication indicia.

26. A system for performing authentication to a secure system comprising:
a portable device having a communication module capable of communicating information in a secure manner;
a speech authentication module adapted to process a user authentication utterance;
said speech authentication module cooperating with said communication module to provide authorization indicia based on the results analyzing said authentication utterance.

27. The system of claim 26 wherein said communication module communicates information to a user.

28. The system of claim 26 wherein said communication module communicates information to a user by audible means.

29. The system of claim 26 wherein said communication module communicates information to a user by visual means.

30. The system of claim 26 wherein said communication module communicates with at least one secure system.

31. The system of claim 30 wherein said speech authentication module cooperates with said communication module to provide authorization indicia to plural secure systems.

32. The system of claim 26 wherein said speech authentication module includes speaker verification models that are trained automatically while the portable device is being used.

33. The system of claim 26 wherein said portable device is a telephone and said speech authentication module includes speaker verification models that are trained automatically while the telephone is being used.

34. The system of claim 26 wherein said speech authentication module employs sequences of random numbers known by the authentication server to effect authentication.

35. The system of claim 26 wherein said speech authentication module includes speaker verification models that are trained automatically while the portable device is being used to thereby bond the device to a particular user.

36. The system of claim 26 wherein said communication module communicates information in a secure manner during a time window whose length depends on the degree of confidence the speech authentication module has that the user is authenticated.

37. A system for performing authentication to a secure system comprising:
a portable device having a communication module capable of communicating information in a secure manner;
a biometric authentication module adapted to process a user authentication utterance;
said biometric authentication module cooperating with said communication module to provide authorization indicia based on the results analyzing said authentication utterance.

38. The system of claim 37 wherein said biometric authentication module employs speech to obtain biometric information about a user.

39. The system of claim 37 wherein said biometric authentication module employs fingerprint data to obtain biometric information about a user.

40. The system of claim 37 wherein said biometric authentication module employs visual data to obtain biometric information about a user.
